(19) United States
(12) Patent Application Publication
(10) Pub. No.: US 2026/0235455 A1
(43) Pub. Date: Aug. 13, 2026

(54) PRESSURE-SENSITIVE SENSOR AND METHOD OF MANUFACTURING THE SAME

(71) Applicant: Proterial, Ltd., Tokyo (JP)

(72) Inventors: Hiroshi YAMADA, Tokyo (JP); Tomoaki SUZUKI, Tokyo (JP); Junichi KIKUCHI, Tokyo (JP); Koji FUKUDA, Tokyo (JP); Kentaro ABE, Tokyo (JP)

(21) Appl. No.: 19/332,183

(22) Filed: Sep. 18, 2025

(30) Foreign Application Priority Data
Feb. 13, 2025 (JP) 2025-021656

(51) Int. Cl. G01L 1/00

(52) U.S. Cl. CPC G01L 1/005

(57) ABSTRACT

An assembly workability of a pressure-sensitive sensor is improved. The pressure-sensitive sensor includes: a hollow outer cover; first to fourth conductive wires which are provided inside the outer cover and are electrically connected to each other in response to elastic deformation of the outer cover; and a conductive wire intertwined portion which is provided at one side of the outer cover in a longitudinal direction and is formed by bringing the second and fourth conductive wires into contact with each other. Thereby, a short-circuit wire for electrically connecting the second and fourth conductive wires can be eliminated, and a welding work for connecting the short-circuit wire can be eliminated. Thus, the assembly workability of the pressure-sensitive sensor can be improved. The number of portions to be welded can be reduced, thereby suppressing occurrence of welding failure or the like.

### CROSS-REFERENCE TO RELATED APPLICATION

The present application claims priority from Japanese Patent Application No. 2025-021656 filed on Feb. 13, 2025, the content of which is hereby incorporated by reference into this application.

### TECHNICAL FIELD OF THE INVENTION

The present invention relates to a pressure-sensitive sensor and a method of manufacturing the same.

### BACKGROUND OF THE INVENTION

For example, Japanese U.S. Pat. No. 5,314,458 (Patent Document 1) describes a cable-shaped sensor including a cylindrical insulating layer and four electrode wires arranged inside the insulating layer. When the insulating layer is elastically deformed by contact with an obstacle, the four electrode wires inside the insulating layer are brought into contact with one another (short-circuited).

### SUMMARY OF THE INVENTION

Two short-circuit wires are provided at one side of a sensor described in the Patent Document 1 in its longitudinal direction. One of the short-circuit wires is connected to one sides of a pair of electrode wires in the longitudinal direction, and the other short-circuit wire is connected to one sides of the other pair of electrode wires in the longitudinal direction. Thus, it is necessary to prepare the two short-circuit wires and connect the short-circuit wires to the electrode wires by welding or the like, and this reduces assembly workability.

An objective of the present invention is to improve the assembly workability of the pressure-sensitive sensor.

According to one aspect of the present invention, a pressure-sensitive sensor is a pressure-sensitive sensor which is elastically deformable in response to contact with an obstacle, and includes: a hollow cable-shaped insulator; at least a pair of conductive wires which are provided inside the cable-shaped insulator and are electrically connected to each other in response to elastic deformation of the cable-shaped insulator; and a conductive wire contact portion which is provided at one side of the cable-shaped insulator in a longitudinal direction and is formed by bringing the pair of conductive wires into contact with each other.

According to another aspect of the present invention, a method of manufacturing a pressure-sensitive sensor is a method of manufacturing a pressure-sensitive sensor which is elastically deformable in response to contact with an obstacle, and includes: a workpiece preparing step of preparing a workpiece made of a hollow cable-shaped insulator and a pair of conductive wires which are provided inside the cable-shaped insulator; a cable-shaped insulator cutting step of cutting the cable-shaped insulator to make the cable-shaped insulator separatable into a main body and a terminal member in a longitudinal direction of the cable-shaped insulator; a conductive wire exposing step of separating the main body and the terminal member from each other to expose the pair of conductive wires between the main body and the terminal member; and a conductive wire contact portion forming step of forming a conductive wire contact portion by bringing the pair of exposed conductive wires into contact with each other.

According to the present invention, assembly workability of a pressure-sensitive sensor can be improved.

### BRIEF DESCRIPTIONS OF THE DRAWINGS

FIG. 1 is a perspective view illustrating a pressure-sensitive sensor according to a first embodiment.

FIG. 2 is a cross-sectional view along a radial direction of the pressure-sensitive sensor.

FIG. 3 is an electric circuit diagram illustrating exemplary use of the pressure-sensitive sensor.

FIG. 4 is a view of a distal-end terminal of the pressure-sensitive sensor in an axial direction.

FIG. 5 is a diagram illustrating view in an arrow A of FIG. 4.

FIG. 6 is a diagram illustrating view in an arrow B of FIG. 4.

FIG. 7 is a diagram illustrating a workpiece preparing step and an outer cover cutting step.

FIG. 8 is a diagram illustrating a conductive wire exposing step.

FIG. 9 is a diagram illustrating a short-circuit wire welding step.

FIG. 10 is a diagram illustrating a clamping step.

FIG. 11 is a diagram illustrating a conductive wire intertwining (twisting) step.

FIG. 12 is a diagram illustrating a terminal member separating step.

FIG. 13 is a diagram corresponding to FIG. 6, which illustrates a pressure-sensitive sensor according to a second embodiment.

FIG. 14 is a diagram illustrating a conductive wire welding step.

FIG. 15 is a diagram corresponding to FIG. 4, which illustrates a pressure-sensitive sensor according to a third embodiment.

FIG. 16 is a diagram illustrating view in an arrow C of FIG. 15.

FIG. 17 is a diagram illustrating view in an arrow D of FIG. 15.

FIG. 18 is a diagram illustrating a first conductive wire intertwining step.

FIG. 19 is a diagram illustrating a second conductive wire intertwining step.

FIG. 20 is a diagram corresponding to FIG. 3, which illustrates a pressure-sensitive sensor according to a fourth embodiment.

### DESCRIPTIONS OF THE PREFERRED EMBODIMENTS

Embodiments of the present invention will be described in detail below with reference to the drawings.

### First Embodiment

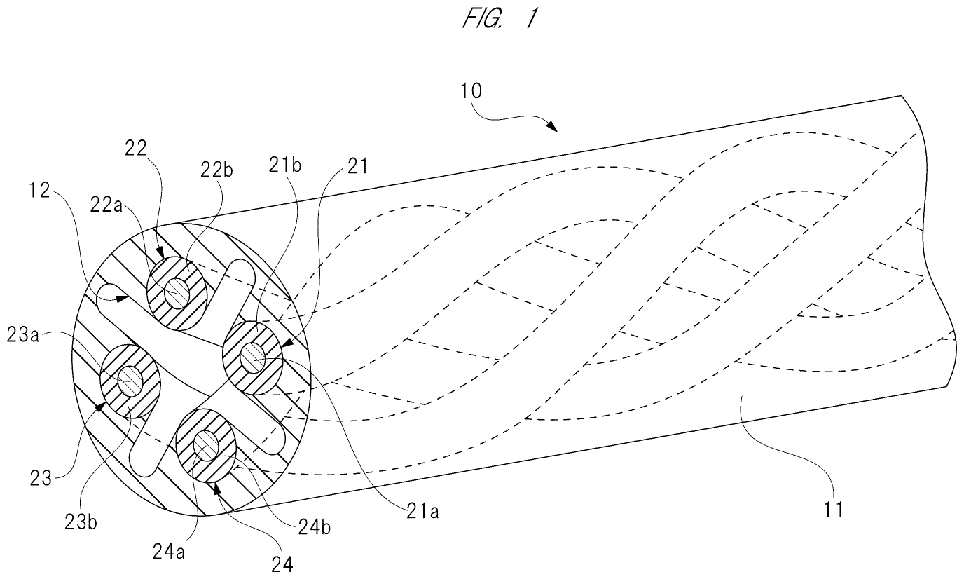

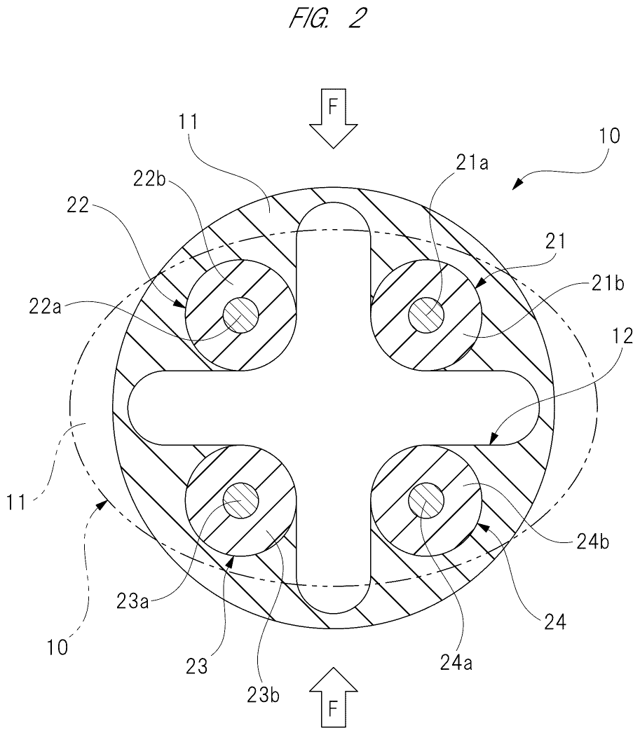

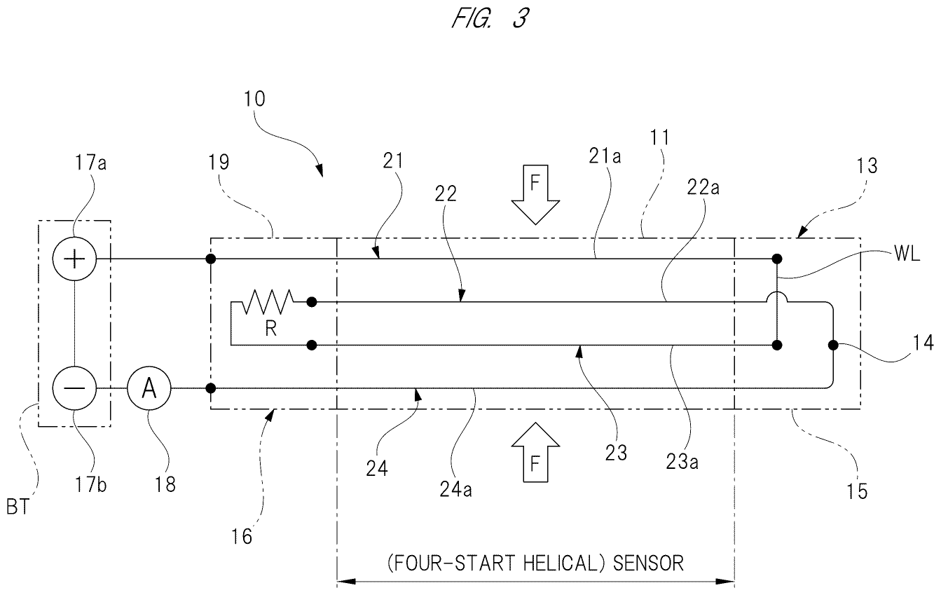

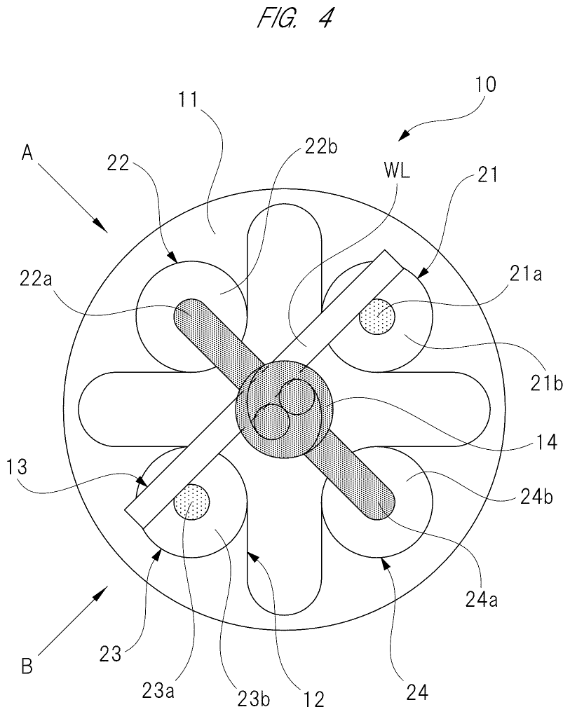

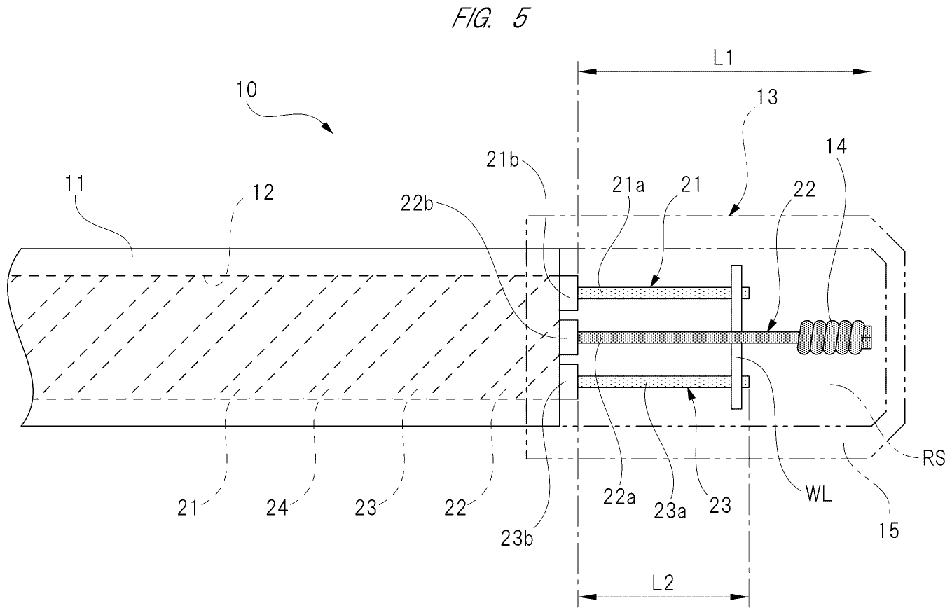

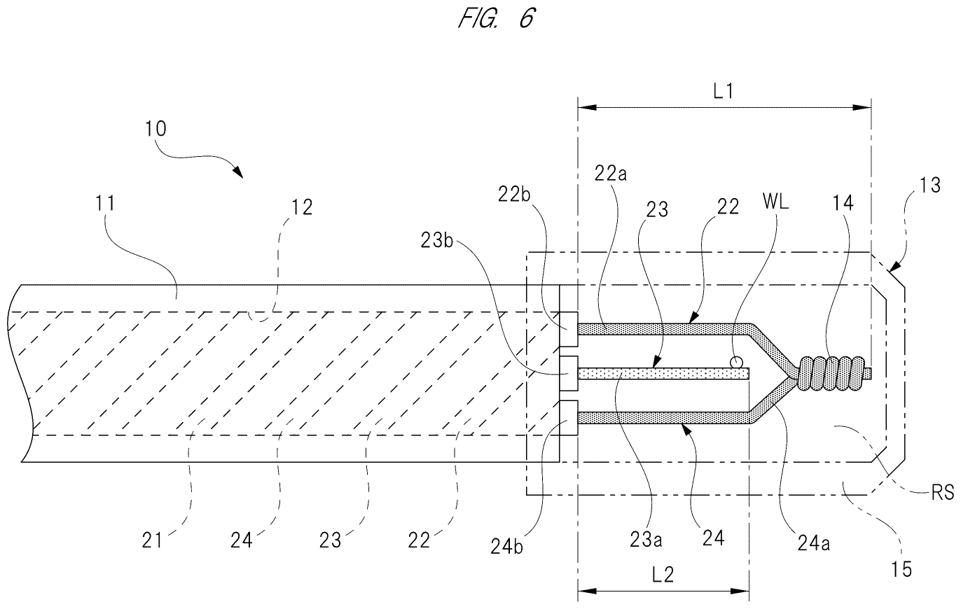

FIG. 1 is a perspective view illustrating a pressure-sensitive sensor according to a first embodiment. FIG. 2 is a cross-sectional view along a radial direction of the pressure-sensitive sensor. FIG. 3 is an electric circuit diagram illustrating exemplary use of the pressure-sensitive sensor. FIG. 4 is a view of a distal-end terminal of the pressure-sensitive sensor in an axial direction. FIG. 5 is a diagram illustrating view in an arrow A of FIG. 4. FIG. 6 is a diagram illustrating view in an arrow B of FIG. 4.

### Outline of Pressure-Sensitive Sensor

A pressure-sensitive sensor 10 illustrated in FIGS. 1 to 6 is mounted on, for example, a sliding door of a vehicle such as car, and is used to sense a passenger or baggage (obstacle) stuck in the sliding door. Specifically, the pressure-sensitive sensor 10 is attached to the front of the sliding door, and is easily elastically deformable in response to contact with the obstacle.

The pressure-sensitive sensor 10 is connected to an in-vehicle controller for controlling the opening/closing operations of the sliding door. The pressure-sensitive sensor 10 transmits a detection signal to the in-vehicle controller in response to its elastic deformation. When sensing the detection signal from the pressure-sensitive sensor 10, the in-vehicle controller switches a rotation direction of an electric motor for driving the sliding door, thereby opening the sliding door being under the closing operation. Thus, the obstacle can be prevented from being stuck in the sliding door.

### Configuration of Pressure-Sensitive Sensor

As illustrated in FIGS. 1 and 2, a cable-shaped outer cover 11 is provided at the pressure-sensitive sensor 10. The outer cover 11 is made of an elastic material such as rubber having an insulating property, and its cross-sectional shape along its short-hand direction (radial direction) crossing its longitudinal direction is a substantially circular shape. The outer cover 11 is formed to have a substantially cylindrical shape, and the outer cover 11 includes, in a radial direction, a first electrode wire 21, a second electrode wire 22, a third electrode wire 23, and a fourth electrode wire 24 therein.

Specifically, the first to fourth electrode wires 21 to 24 are equidistant (at 90-degree interval) from one another in a circumferential direction of the outer cover 11, and helically extend in the longitudinal direction of the outer cover 11. In the radial direction, the outer cover 11 includes the first to fourth electrode wires 21 to 24 that are not in contact with one another and are arranged with a four-start helical structure.

In the radial direction, the outer cover 11 further includes a hollow 12 that is substantially cross-shaped when being viewed in the axial direction of the outer cover 11. That is, the outer cover 11 is hollow. Thereby, the pressure-sensitive sensor 10 (the outer cover 11) is elastically deformable in response to application of external force F as illustrated with a dashed double-dotted line in FIG. 2. The first to fourth electrode wires 21 to 24, which are included in the outer cover 11 in the radial direction and are arranged around the hollow 12, are brought into contact with and are electrically connected to one another (short-circuited) in response to the elastic deformation of the outer cover 11. Note that the outer cover 11 is equivalent to the cable-shaped insulator according to the present invention.

As illustrated in FIGS. 1 and 2, the first to fourth electrode wires 21 to 24 have the same configuration as one another. Specifically, the first to fourth electrode wires 21 to 24 are made of first to fourth conductive wires 21a to 24a made of intertwined thin copper wires, and first to fourth conductive rubbers 21b to 24b covering the first to fourth conductive wires 21a to 24a, respectively. Thus, in response to the application of the external force F to the outer cover 11 and the elastic deformation of the outer cover 11, the first to fourth conductive rubbers 21b to 24b are brought into contact with one another, and the first to fourth conductive wires 21a to 24a inside the first to fourth conductive rubbers 21b to 24b are electrically connected to one another.

As a material of each of the first to fourth conductive rubbers 21b to 24b, note that, for example, silicon rubber or the like containing carbon black, metal powder, or the like is used. <Distal-End Terminal>

As illustrated in FIGS. 3 to 6, a distal-end terminal 13 is provided at one side (in FIGS. 3, 5, and 6, the right side) of the pressure-sensitive sensor 10 in the longitudinal direction. One sides (distal-end sides) of the first and third conductive wires 21a and 23a exposed from the outer cover 11 in the longitudinal direction are provided at the distal-end terminal 13. The pair of first and third conductive wires 21a and 23a can be electrically connected to each other via a short-circuit wire WL.

The short-circuit wire WL is a copper rod body, and extends in the radial direction of the pressure-sensitive sensor 10. Both ends of the short-circuit wire WL in the longitudinal direction are fixed to the first and third conductive wires 21a and 23a, respectively, by soldering, welding, or the like.

Further, one sides (distal-end sides) of the second and fourth conductive wires 22a and 24a exposed from the outer cover 11 in the longitudinal direction are provided at the distal-end terminal 13. At one side of the pressure-sensitive sensor 10 in the longitudinal direction, a length L1 of each of the second and fourth conductive wires 22a and 24a exposed from the outer cover 11 is larger than a length L2 of each of the first and third conductive wires 21a and 23a exposed from the outer cover 11 (L1>L2).

One sides of the pair of second and fourth conductive wires 22a and 24a in the longitudinal direction are brought into contact with each other by being collectively helically intertwined. That is, the pair of second and fourth conductive wires 22a and 24a can be electrically connected to each other without the use of the short-circuit wire WL. Specifically, the second and fourth conductive wires 22a and 24a are directly connected to each other by being collectively intertwined around five times.

The contact portion between the second and fourth conductive wires 22a and 24a serves as a conductive wire intertwined portion 14 which is formed by intertwining one sides of the second and fourth conductive wires 22a and 24a in the longitudinal direction. The conductive wire intertwined portion 14 is arranged at a portion of one side of the pressure-sensitive sensor 10 in the longitudinal direction, the portion being the closest to the distal end.

As described above, the conductive wire intertwined portion 14, which is formed by bringing the second and fourth conductive wires 22a and 24a into contact, is provided at one sides of the second and fourth conductive wires 22a and 24a in the longitudinal direction. Note that the conductive wire intertwined portion 14 is equivalent to the conductive wire contact portion according to the present invention. The conductive wire contact portion means a portion where one of the pair of conductive wires is brought into direct contact with the other thereof.

As illustrated in FIGS. 5 and 6, the short-circuit wire WL crosses the second and fourth conductive wires 22a and 24a, and is not in contact with the second and fourth conductive wires 22a and 24a and the conductive wire intertwined portion 14. At the distal-end terminal 13, the pair of first and third conductive wires 21a and 23a are not in contact with the pair of second and fourth conductive wires 22a and 24a.

A distal-end cap 15 made of an insulator such as transparent rubber is further provided at the distal-end terminal 13. The distal-end cap 15 covers the first and third conductive wires 21a and 23a, the short-circuit wire WL, the second and fourth conductive wires 22a and 24a, and the conductive wire intertwined portion 14.

The distal-end cap 15 is filled with an ultraviolet-curable resin RS which is cured by ultraviolet irradiation. The ultraviolet-curable resin RS has an insulation property. Therefore, at the distal-end terminal 13, the pair of first and third conductive wires 21a and 23a, the pair of second and fourth conductive wires 22a and 24a, the short-circuit wire WL, and the conductive wire intertwined portion 14 are sealed with the ultraviolet-curable resin RS such that they do not mutually short-circuit.

Note that the ultraviolet-curable resin RS is equivalent to the sealing material according to the present invention. The sealing material is not limited to the ultraviolet-curable resin RS, and a thermo-curable resin having the insulation property or the like may be used.

As described above, the pair of first and third conductive wires 21a and 23a and the pair of second and fourth conductive wires 22a and 24a are provided at the pressure-sensitive sensor 10. In other words, two pairs of conductive wires in total are provided at the pressure-sensitive sensor 10.

### Proximal-End Terminal

As illustrated in FIG. 3, a proximal-end terminal 16 is provided at the other side (in FIG. 3, the left side) of the pressure-sensitive sensor 10 in the longitudinal direction. The other sides of the first to fourth conductive wires 21a to 24a exposed from the outer cover 11 in the longitudinal direction are provided at the proximal-end terminal 16. A resistor R is provided at the proximal-end terminal 16. The resistor R is fixed to the second and third conductive wires 22a and 23a by soldering, welding, or the like.

At the proximal-end terminal 16, a positive terminal 17a of a battery BT is connected to the first conductive wire 21a, and a negative terminal 17b of the battery BT is connected to the fourth conductive wire 24a via a current detector 18. The current detector 18 detects a current value of a current flowing through the first to fourth conductive wires 21a to 24a connected in series.

Specifically, in a state without the application of the external force F to the outer cover 11, in other words, in a case without the elastic deformation of the outer cover 11, the current detector 18 detects a current value a1 of a current flowing through the first to fourth conductive wires 21a to 24a via the resistor R. To the contrary, in a state with the application of the external force F to the outer cover 11, the first to fourth conductive wires 21a to 24a are mutually short-circuited via the first to fourth conductive rubbers 21b to 24b (see FIGS. 1 and 2) in response to the elastic deformation of the outer cover 11. Thus, the current detector 18 detects a larger current value a2 (a2>a1) flowing not via the resistor R.

As illustrated in FIG. 3, a portion of the pressure-sensitive sensor 10 in the longitudinal direction, where the first to fourth electrode wires 21 to 24 are arranged with the four-start helix structure, in other words, a portion thereof corresponding to the outer cover 11 serves as a sensor which is elastically deformable in response to contact with the obstacle.

The current detector 18 is connected to the in-vehicle controller, and the in-vehicle controller senses a change from the smaller current value a1 to the larger current value a2, thereby finding the fact that the obstacle is in contact with the pressure-sensitive sensor 10. Then, when sensing the detection signal (the increase in the current value) output from the pressure-sensitive sensor 10 and determining that the obstacle is in contact with the pressure-sensitive sensor 10, the in-vehicle controller immediately reverses the rotation direction of the electric motor. Thus, the sliding door under the closing operation is opened to prevent the obstacle from being stuck in the sliding door.

Note that a proximal-end cap 19 made of an insulator such as transparent rubber is provided at the proximal-end terminal 16. The proximal-end cap 19 covers the first to fourth conductive wires 21a to 24a and the resistor R.

As similar to the distal-end cap 15, the proximal-end cap 19 is filled with an ultraviolet-curable resin (sealing material) having an insulation property. Thus, at the proximal-end terminal 16, the first to fourth conductive wires 21a to 24a and the resistor R do not mutually short-circuit. <Method of Manufacturing Pressure-Sensitive Sensor>

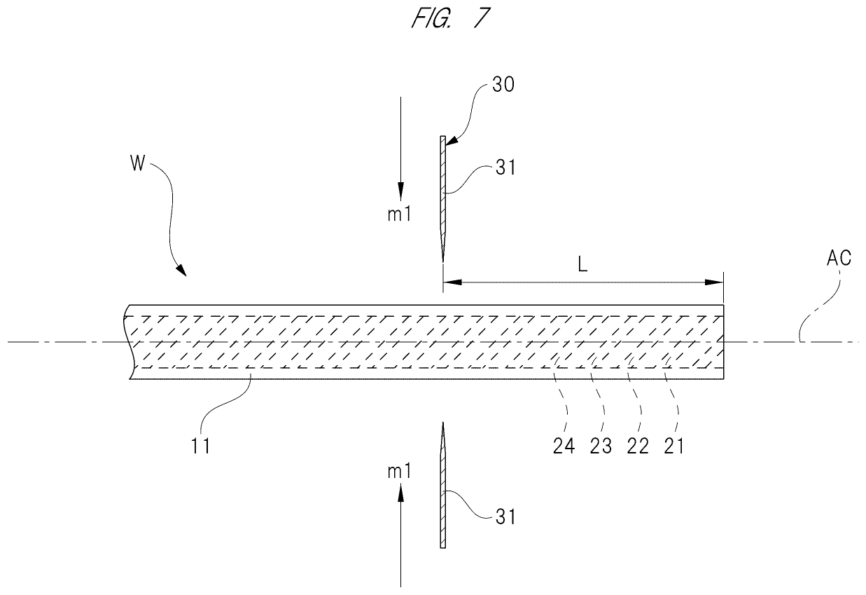

Next, a method of manufacturing the pressure-sensitive sensor 10 formed as described above, particularly an assembly procedure of the distal-end terminal 13 (see FIGS. 5 and 6) will be described with reference to FIGS. 7 to 12.

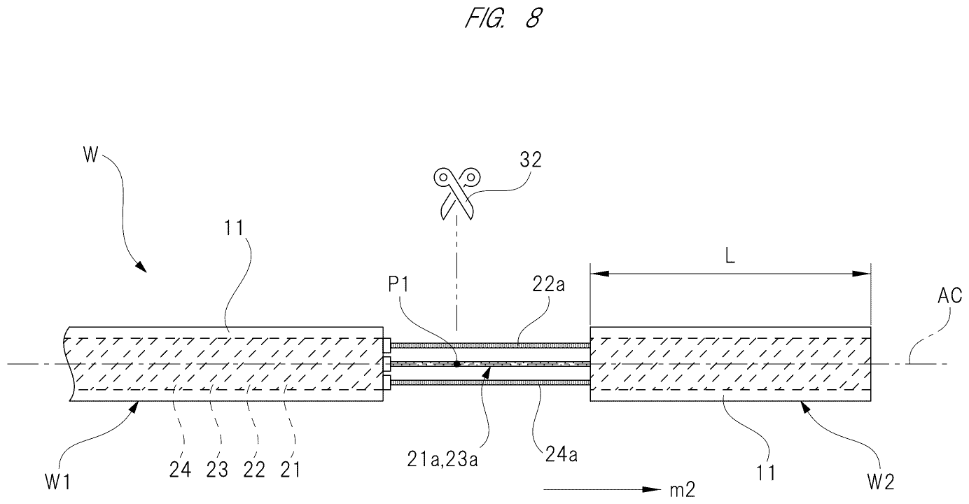

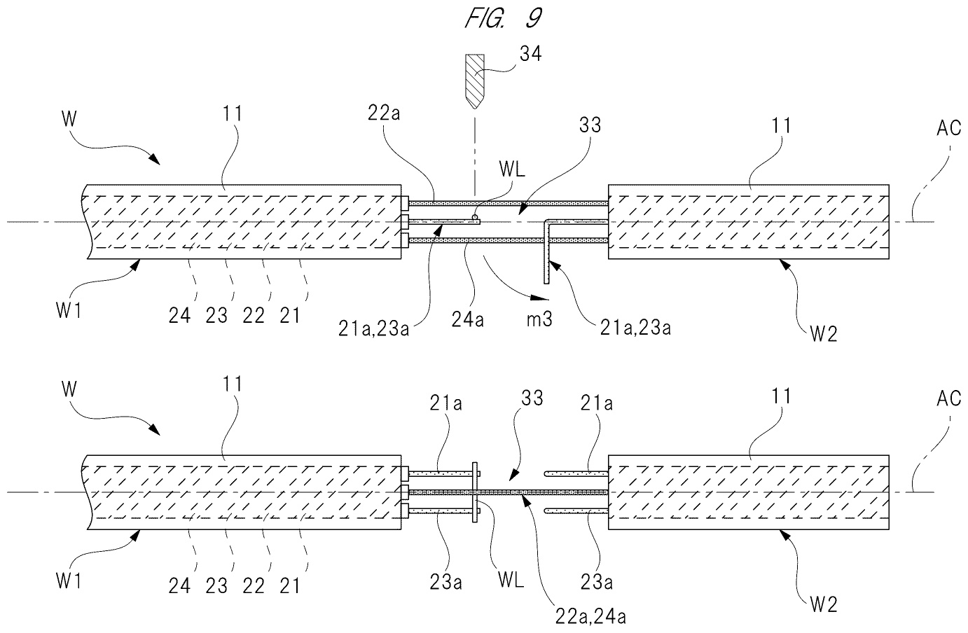

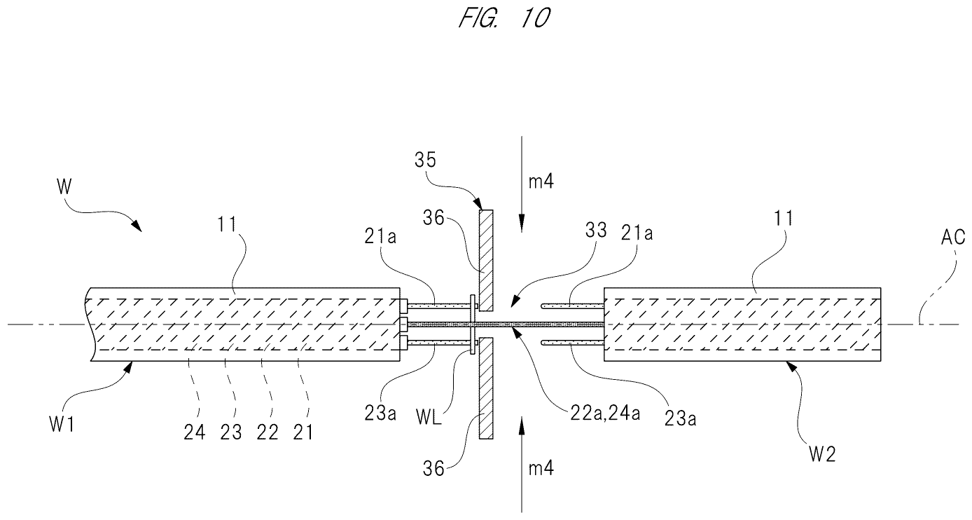

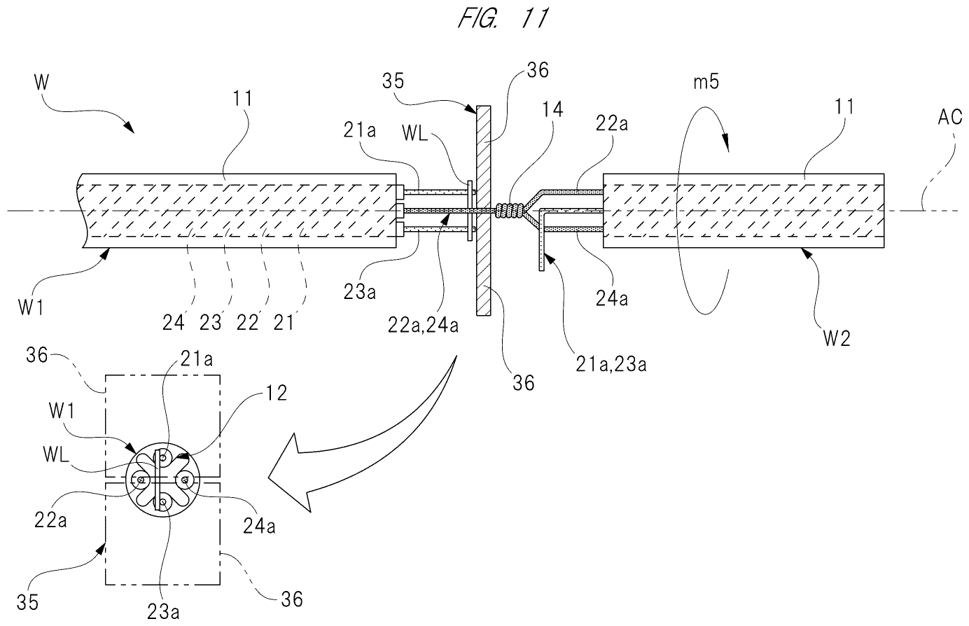

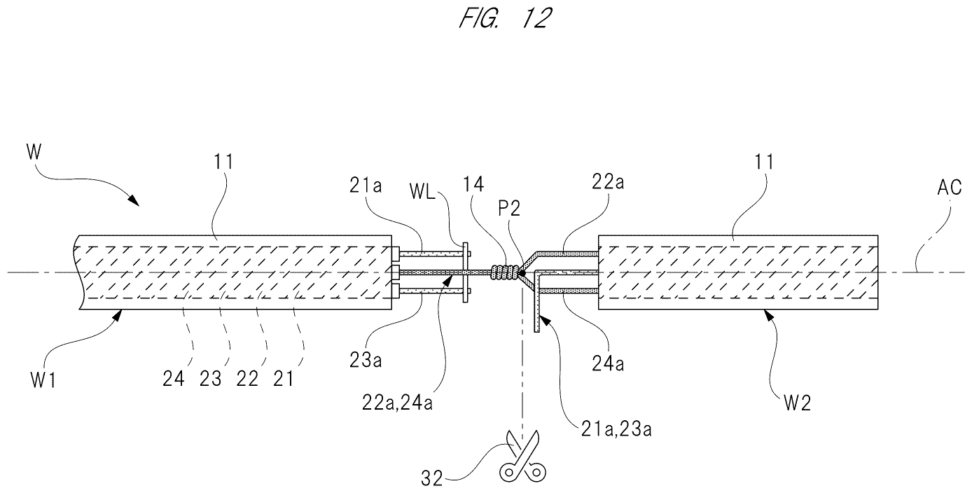

FIG. 7 is a diagram illustrating a workpiece preparing step and an outer cover cutting step. FIG. 8 is a diagram illustrating a conductive wire exposing step. FIG. 9 is a diagram illustrating a short-circuit wire welding step. FIG. 10 is a diagram illustrating a clamping step. FIG. 11 is a diagram illustrating a conductive wire intertwining step. FIG. 12 is a diagram illustrating a terminal member separating step.

### Workpiece Preparing Step

At first, an elongate workpiece W cut to a predetermined length is prepared as illustrated in FIG. 7. The workpiece W described herein is a substance in which the hollow 12 and the first to fourth electrode wires 21 to 24 are provided inside the outer cover 11 as illustrated in FIGS. 1 and 2. Also, the workpiece W is a substance in a state before processing the distal-end and proximal-end terminals in the longitudinal direction.

Note that the workpiece W is formed to be elongated by an extruder that extrudes an insulating material with bendability to be the outer cover 11, together with the first to fourth electrode wires 21 to 24.

### Outer Cover Cutting Step

Next, as illustrated in FIG. 7, a pair of cutting blades 31 forming a wire stripper 30 are arranged at a portion that is a predetermined distance L away from one side of the workpiece W in its longitudinal direction. Thereafter, the pair of cutting blades 31 are moved to come close to each other radially from outside the workpiece W as illustrated with arrows m1. A cutout having a depth nearly reaching the first to fourth conductive wires 21a to 24a (see FIGS. 1 and 2) is formed on the outer periphery of the workpiece W.

Thereby, the cutout is formed on the outer cover 11 and the first to fourth conductive rubbers 21b to 24b (see FIGS. 1 and 2) without cutting the first to fourth conductive wires 21a to 24a. Thus, the outer cover 11 and the first to fourth conductive rubber 21b to 24b are separatable into a main body W1 and a terminal member W2 in the longitudinal direction (see FIG. 8). Note that the outer cover cutting step is equivalent to the cable-shaped insulator cutting step according to the present invention.

### Conductive Wire Exposing Step

Next, as illustrated in FIG. 8, parts of the first to fourth conductive wires 21a to 24a between the main body W1 and the terminal member W2 are exposed out. Specifically, the main body W1 and the terminal member W2 are slowly separated from each other in the longitudinal direction of the workpiece W as illustrated with an arrow m2. Thereby, the parts of the first to fourth conductive wires 21a to 24a between the main body W1 and the terminal member W2 are exposed out.

At this time, since the first to fourth conductive wires 21a to 24a are helically provided at the outer cover 11, the main body W1 and the terminal member W2 may be separated from each other while being relatively rotated around an axis AC of them. Thereby, it is unnecessary to apply a large tension to the first to fourth conductive wires 21a to 24a in the longitudinal direction.

Thereafter, the first and third conductive wires 21a and 23a are cut at a cutting point P1 by use of a cutting tool 32 such as scissors. Thereby, at one side (in FIG. 8, the right side) of the main body W1 in the longitudinal direction, the first and third conductive wires 21a and 23a exposed from the outer cover 11 each have a length L2 (see FIGS. 5 and 6).

### Short-Circuit Wire Welding Step

Then, the first and third conductive wires 21a and 23a on the terminal member W2 side are bent substantially at right angle as illustrated with an arrow m3 in FIG. 9. Thereby, a relatively large space 33 is formed at the distal-end sides (in FIG. 9, the right sides) of the first and third conductive wires 21a and 23a on the main body W1 side. Since the space 33 is provided as described above, a work for welding the short-circuit wire WL and a work for a subsequent conductive wire intertwining step (see FIG. 11) can be easily performed.

Then, the short-circuit wire WL is arranged to bridge the first conductive wire 21a and the third conductive wire 23a, and a welding tool 34 is applied to the short-circuit wire WL. Both sides of the short-circuit wire WL in its longitudinal direction are fixed to the first conductive wire 21a and the third conductive wire 23a, respectively. Thereby, the first and third conductive wires 21a and 23a can be electrically connected to each other via the short-circuit wire WL.

At the welded portion of the short-circuit wire WL, note that the first and third conductive rubbers 21b and 23b are peeled off to expose the first and third conductive wires 21a and 23a. Thereby, the strength of the fixation of the short-circuit wire WL to the first and third conductive wires 21a and 23a can be sufficiently ensured.

A lower diagram of FIG. 9 illustrates a state in which the main body W1 and the terminal member W2 in an upper diagram of FIG. 9 are rotated around the axis AC by 90 degrees.

### Clamping Step

Then, as illustrated in FIG. 10, the workpiece W is arranged between a pair of claws 36 of a clamper 35. Specifically, a part of the workpiece W in the longitudinal direction, the part being close to the short-circuit wire WL and being on the terminal member W2 side (in FIG. 10, the right side) of the short-circuit wire WL, is arranged between the pair of claws 36. Note that the workpiece W is arranged such that a direction (in FIG. 10, an up-and-down direction) orthogonal to an arrangement direction (in FIG. 10, a depth direction) of the second and fourth conductive wires 22a and 24a is a movement direction of the pair of claws 36.

Then, the pair of claws 36 are moved to come close to each other as illustrated with arrows m4 such that the second and fourth conductive wires 22a and 24a are clamped by the pair of claws 36. Thereby, the second and fourth conductive wires 22a and 24a are fixed between the pair of claws 36 such that a distance between the second and fourth conductive wires 22a and 24a does not change.

### Conductive Wire Intertwining Step

Then, as illustrated in FIG. 11, a work for forming the helical conductive wire intertwined portion 14 at a part of the pair of claws 36 on the terminal member W2 side in the longitudinal direction of the workpiece W is performed. Specifically, the terminal member W2 is rotated around the axis AC relatively to the main body W1 as illustrated with an arrow m5 in a state in which the second and fourth conductive wires 22a and 24a are clamped by the pair of claws 36. Thereby, the second and fourth conductive wires 22a and 24a exposed from the outer cover 11 are collectively intertwined to be electrically connected to each other.

Thereby, the conductive wire intertwined portion 14 is formed at the part of the pair of claws 36 on the terminal member W2 side in the longitudinal direction of the workpiece W. In the present embodiment, the terminal member W2 is intertwined five times relatively to the main body W1. Note that the conductive wire intertwining step is equivalent to the conductive wire contact portion forming step according to the present invention.

### Terminal Member Separating Step

Then, as illustrated in FIG. 12, the second and fourth conductive wires 22a and 24a are cut at a cutting point P2 by use of the cutting tool 32. Specifically, the cutting point P2 is positioned at a part of the second and fourth conductive wires 22a and 24a in the longitudinal direction, the part being closer to a side with the terminal member W2 than the conductive wire intertwined portion 14 and close to the conductive wire intertwined portion 14. Thereby, the terminal member W2 is separated from the main body W1.

### Sealing Step

Then, the distal-end cap 15 is mounted at one side (in FIGS. 5 and 6, the right side) of the main body W1 in the longitudinal direction, and the distal-end cap 15 is filled with the ultraviolet-curable resin RS. Then, the distal-end cap 15 is irradiated with ultraviolet ray by use of the ultraviolet ray, thereby curing the ultraviolet-curable resin RS. Thereby, the conductive wire intertwined portion 14 and the like at one side of the main body W1 in the longitudinal direction are sealed with the ultraviolet-curable resin RS, and the assembly of the distal-end terminal 13 of the pressure-sensitive sensor 10 is completed.

As described in detail above, the pressure-sensitive sensor 10 according to the first embodiment includes: the hollow outer cover 11; the first to fourth conductive wires 21a to 24a which are provided inside the outer cover 11 and can be electrically connected to each other in response to the elastic deformation of the outer cover 11; and the conductive wire intertwined portion 14 which is provided at one side of the outer cover 11 in the longitudinal direction and is formed by bringing the second and fourth conductive wires 22a and 24a into contact.

Thereby, the short-circuit wire for electrically connecting the second and fourth conductive wires 22a and 24a can be eliminated, and the work for connecting the short-circuit wire can be eliminated. Thus, the assembly workability of the pressure-sensitive sensor 10 can be improved. Also, the number of portions to be welded can be reduced, thereby suppressing welding failure or the like.

The pressure-sensitive sensor 10 according to the first embodiment includes the conductive wire intertwined portion 14 formed by intertwining one sides of the second and fourth conductive wires 22a and 24a in the longitudinal direction.

Thus, by simply rotating the terminal member W2 around the axis AC relatively to the main body W1, the second and fourth conductive wires 22a and 24a can be brought into direct contact and be reliably electrically connected to each other.

Additionally, in the pressure-sensitive sensor 10 according to the first embodiment, the conductive wire intertwined portion 14 is sealed with the ultraviolet-curable resin RS having the insulation property.

Thereby, the short circuit among the pair of first and third conductive wires 21a and 23a, the pair of second and fourth conductive wires 22a and 24a, the short-circuit wire WL, and the conductive wire intertwined portion 14 can be reliably prevented.

### Second Embodiment

Next, a second embodiment of the present invention will be described in detail with reference to the drawings. The components having the same functions as those of the first embodiment are denoted with the same reference symbols, and the detailed description thereof is omitted.

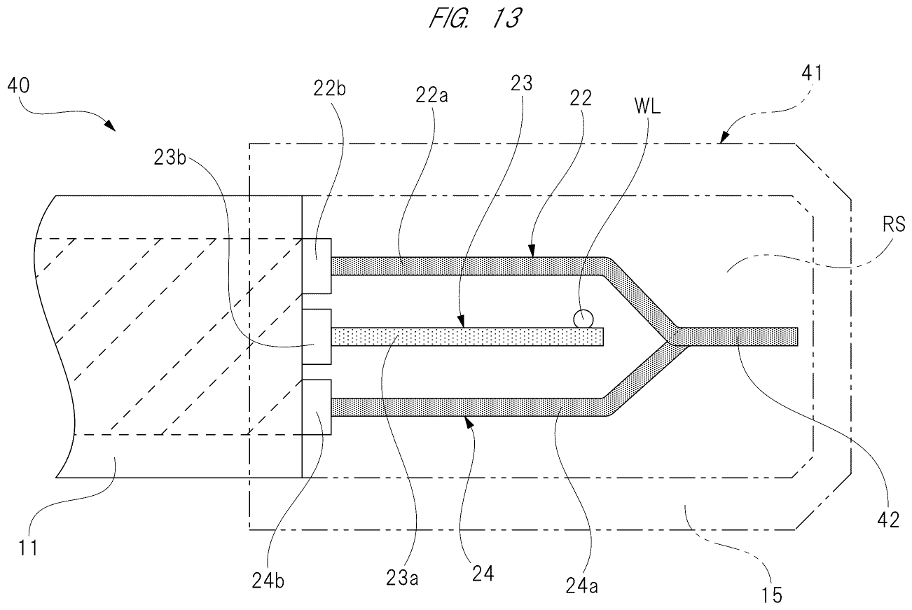

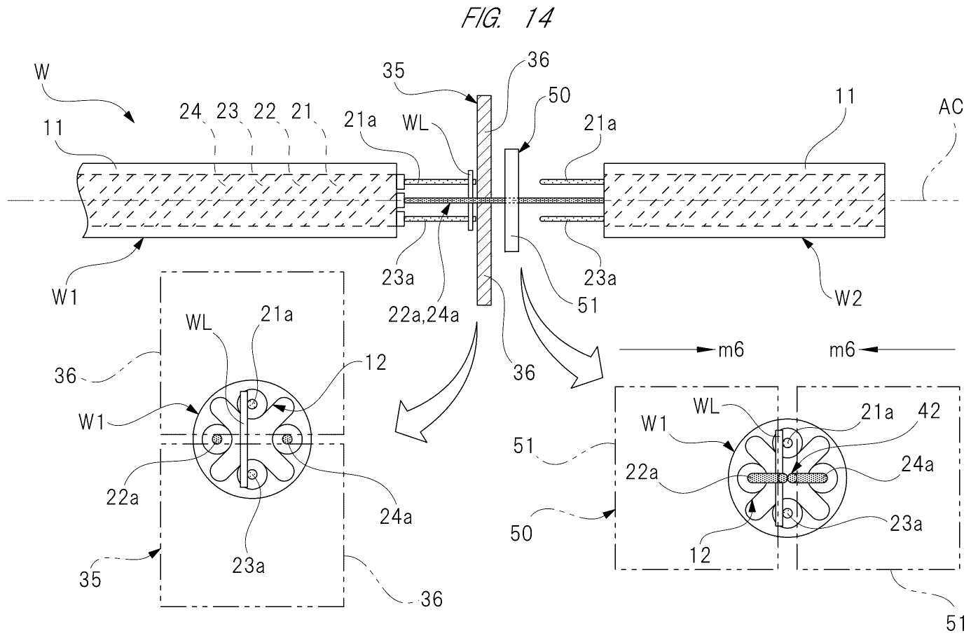

FIG. 13 is a diagram corresponding to FIG. 6, which illustrates a pressure-sensitive sensor according to the second embodiment. FIG. 14 is a diagram illustrating a conductive wire welding step.

As illustrated in FIG. 13, the pressure-sensitive sensor 40 according to the second embodiment is different from the pressure-sensitive sensor 10 (see FIG. 6) according to the first embodiment in a configuration of a distal-end terminal 41. Specifically, instead of the conductive wire intertwined portion 14 (see FIG. 6) according to the first embodiment, a conductive wire welded portion 42 is provided at the distal-end terminal 41 according to the second embodiment.

Specifically, the conductive wire welded portion 42 is provided at one side (in FIG. 13, the right side) of the outer cover 11 in the longitudinal direction, and is formed by bringing the second and fourth conductive wires 22a and 24a exposed from the outer cover 11 into contact. Note that the conductive wire welded portion 42 is equivalent to the conductive wire contact portion according to the present invention.

The conductive wire welded portion 42 bundles one sides of the pair of second and fourth conductive wires 22a and 24a in the longitudinal direction into one bunch, and both of them are welded, thereby electrically connecting them. Specifically, the conductive wire welded portion 42 is formed in the following conductive wire welding step. Note that the conductive wire welding step is performed instead of the conductive wire intertwining step according to the first embodiment (see FIG. 11).

### Conductive Wire Welding Step

As illustrated in FIG. 14, in the conductive wire welding step, a work for forming the conductive wire welded portion 42 at a part of the pair of claws 36 on the terminal member W2 side in the longitudinal direction of the workpiece W is performed by use of a welder 50. The welder 50 described herein is a resistance welder, and includes a pair of electrode members 51. A movement direction of the pair of electrode members 51 is a direction orthogonal to the movement direction of the pair of claws 36.

As illustrated in FIG. 14, the pair of electrode members 51 are moved to come close to each other as illustrated with arrows m6 in a state in which the second and fourth conductive wires 22a and 24a are clamped by the pair of claws 36. Thereby, the terminal member W2 sides of the second and fourth conductive wires 22a and 24a exposed from the outer cover 11 are clamped by the pair of electrode members 51, thereby bringing them into contact with each other.

Then, a current is caused to flow through the pair of electrode members 51. Accordingly, the contact portion between the second and fourth conductive wires 22a and 24a is heated and melted, thereby forming the conductive wire welded portion 42. Note that the conductive wire welding step is equivalent to the conductive wire contact porting forming step according to the present invention. In the conductive wire welding step, the contact portion between the second and fourth conductive wires 22a and 24a may be welded by not the above resistance welding but, for example, ultrasonic welding or the like.

Even in the pressure-sensitive sensor 40 according to the second embodiment formed as described above, the short-circuit wire for electrically connecting the second and fourth conductive wires 22a and 24a can be eliminated as similar to the first embodiment. Thus, the assembly workability of the pressure-sensitive sensor can be improved. In the second embodiment, one sides of the pair of second and fourth conductive wires 22a and 24a in the longitudinal direction are welded to each other, thereby forming the conductive wire welded portion 42. Therefore, the second and fourth conductive wires 22a and 24a can be more reliably electrically connected to each other.

### Third Embodiment

Next, a third embodiment of the present invention will be described in detail with reference to the drawings. Note that the components having the functions similar to those in the first embodiment are denoted with the same reference symbols, and the detailed description thereof is omitted.

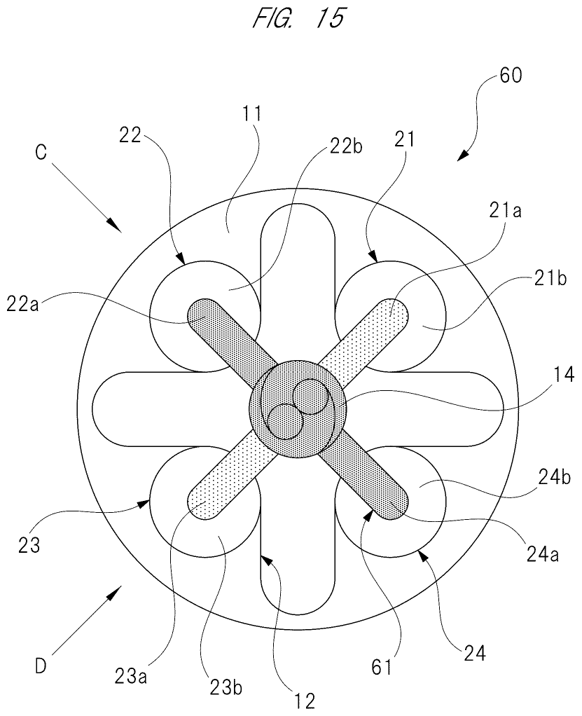

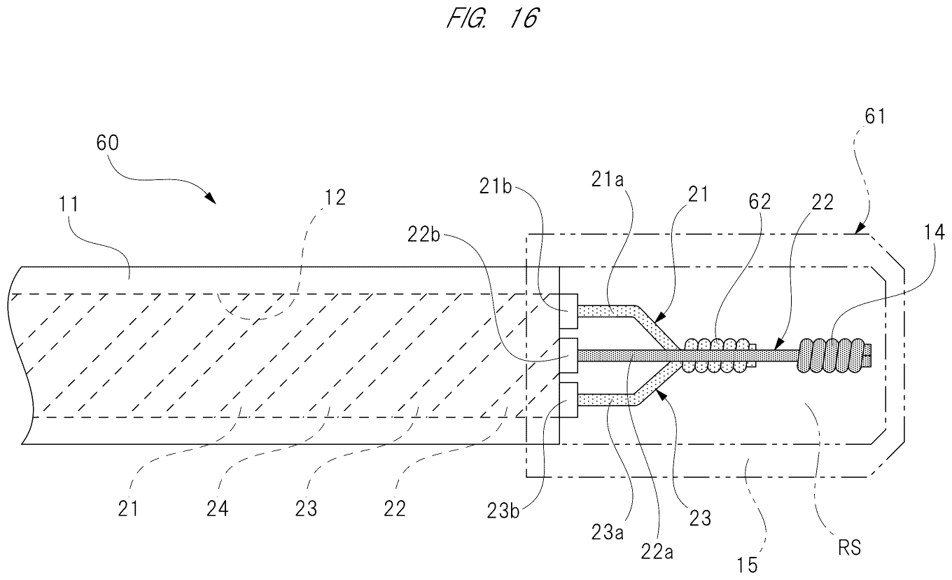

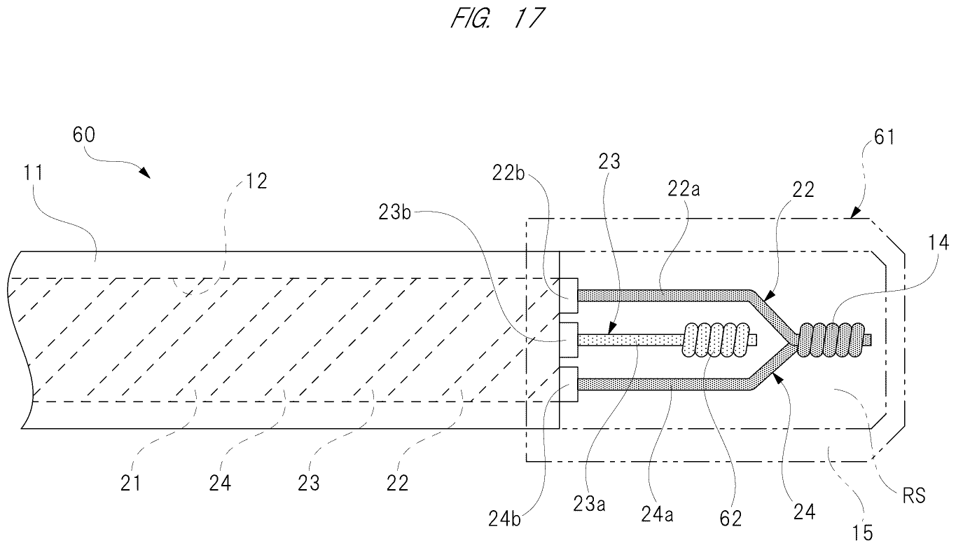

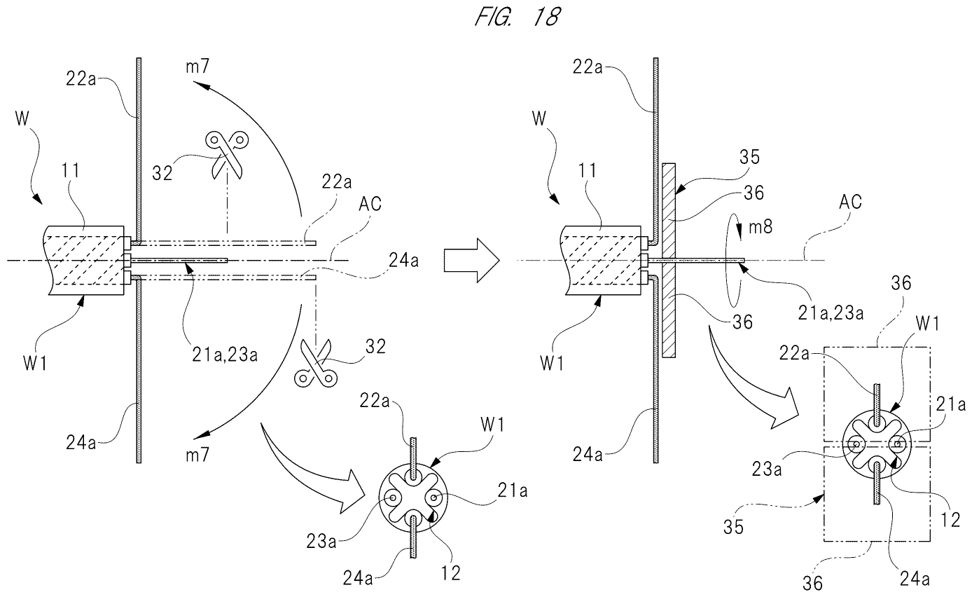

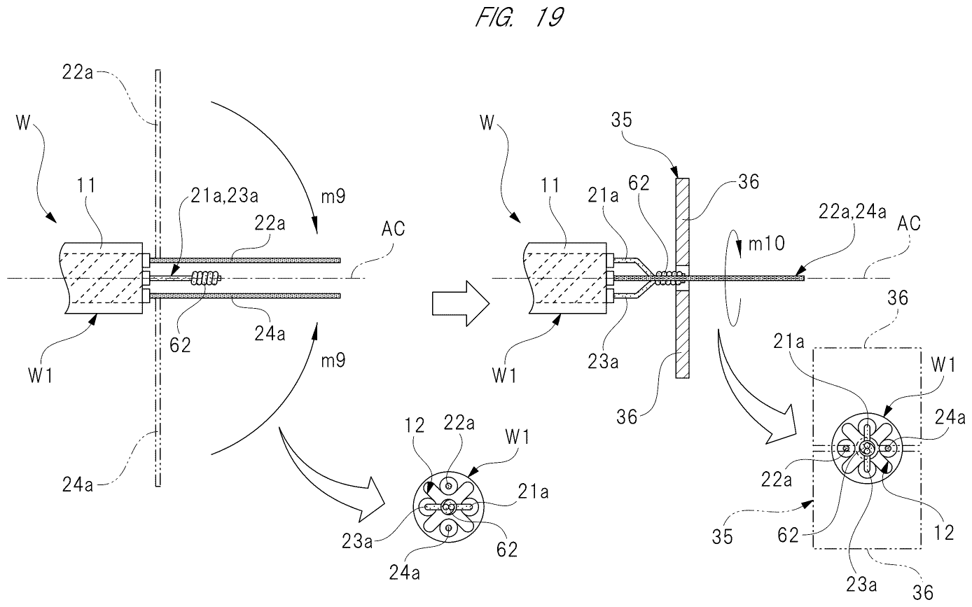

FIG. 15 is a diagram corresponding to FIG. 4, which illustrates a pressure-sensitive sensor according to the third embodiment. FIG. 16 is a diagram illustrating view in an arrow C of FIG. 15. FIG. 17 is a diagram illustrating view in an arrow D of FIG. 15. FIG. 18 is a diagram illustrating a first conductive wire intertwining step. FIG. 19 is a diagram illustrating a second conductive wire intertwining step.

As illustrated in FIGS. 15 to 17, the pressure-sensitive sensor 60 according to the third embodiment is different from the pressure-sensitive sensor 10 (see FIGS. 4 to 6) according to the first embodiment in a configuration of a distal-end terminal 61. Specifically, in the distal-end terminal 61 according to the third embodiment, the short-circuit wire WL used in the first embodiment is eliminated, and a conductive wire intertwined portion 62 is provided also at one side (in FIGS. 16 and 17, the right side) of the pair of first and third conductive wires 21a and 23a in the longitudinal direction. That is, at the distal-end terminal 61 according to the third embodiment, a pair of conductive wire intertwined portions 14 and 62 (one conductive wire intertwined portion 14 and the other conductive wire intertwined portion 62) are provided.

Specifically, the other conductive wire intertwined portion 62 is provided at one side (in FIGS. 16 and 17, the right side) of the pair of first and third conductive wires 21a and 23a in the longitudinal direction, and is formed by collectively intertwining the first and third conductive wires 21a and 23a exposed from the outer cover 11. Note that the other conductive wire intertwined portion 62 is equivalent to the conductive wire contact portion according to the present invention.

The other conductive wire intertwined portion 62 is formed by the first conductive wire intertwining step illustrated in FIG. 18. Also, the one conductive wire intertwined portion 14 is formed by the second conductive wire intertwining step illustrated in FIG. 19. A method of manufacturing the pressure-sensitive sensor 60 according to the third embodiment, particularly an assembly procedure of the distal-end terminal 61 (see FIGS. 16 and 17) will be described below.

As steps prior to the first conductive wire intertwining step, the workpiece preparing step, the outer cover cutting step, the conductive wire exposing step, and the clamping step are performed as similar to the first embodiment. However, in the conductive wire exposing step according to the third embodiment, the main body W1 and the terminal member W2 (see FIG. 8) are divided from each other, and the first to fourth conductive wires 21a to 24a are partially exposed, and then, all the first to fourth conductive wires 21a to 24a are cut to separate the terminal member W2 from the main body W1.

Specifically, as illustrated in the left drawing of FIG. 18, the exposed portions of the first and third conductive wires 21a and 23a are cut to the same length by use of the cutting tool 32. The exposed portions of the second and fourth conductive wires 22a and 24a are cut to the same length by use of the cutting tool 32. Note that a length of the exposed portion of each of the second and fourth conductive wires 22a and 24a is substantially twice larger than a length of the exposed portion of each of the first and third conductive wires 21a and 23a.

Thereafter, as illustrated with arrows m7, the exposed portions of the second and fourth conductive wires 22 a and 24 a are bent at their roots by 90 degrees in opposite directions to each other (in an up-and-down direction in the drawing). Thereby, a work for intertwining the exposed portions of the first and third conductive wires 21a and 23a (the first conductive wire intertwining step) can be performed.

In the clamping step according to the third embodiment, the vicinities of the roots of the exposed portions of the first and third conductive wires 21a and 23a are clamped by the pair of claws 36 as illustrated in the right drawing of FIG. 18. Thereby, the first and third conductive wires 21a and 23a are fixed between the pair of claws 36 such that the distance between the first and third conductive wires 21a and 23a does not change.

### First Conductive Wire Intertwining Step

Next, in a state in which the first and third conductive wires 21a and 23a are clamped by the pair of claws 36, the distal sides (in FIG. 18, the right sides) of the first and third conductive wires 21a and 23a are collectively intertwined around the axis AC as illustrated with an arrow m8, and are brought into contact with each other.

Thereby, as illustrated in FIG. 19, the conductive wire intertwined portion 62 is formed at the exposed portions of the first and third conductive wires 21a and 23a. Note that the other conductive wire intertwined portion 62 is formed by intertwining the distal-end sides of the first and third conductive wires 21a and 23a five times. The first conductive wire intertwining step is equivalent to the conductive wire contact portion forming step according to the present invention.

### Second Conductive Wire Intertwining Step

Next, as illustrated with arrows m9 in the left drawing of FIG. 19, the second and fourth conductive wires 22 a and 24 a, which are bent by 90 degrees in the opposite directions to each other, are unbent to the original position along the axis AC. Thereafter, as illustrated in the right drawing of FIG. 19, the second and fourth conductive wires 22a and 24a are clamped by the pair of claws 36. Thereby, the second and fourth conductive wires 22a and 24a are fixed between the pair of claws 36 such that the distance between the second and fourth conductive wires 22a and 24a does not change.

Then, in a state in which the second and fourth conductive wires 22a and 24a are clamped, the distal-end sides (in FIG. 19, the right sides) of the second and fourth conductive wires 22a and 24a are collectively intertwined around the axis AC as illustrated with an arrow m10 in the right drawing of FIG. 19, and are brought into contact with each other.

Thereby, as illustrated in FIGS. 16 and 17, the one conductive wire intertwined portion 14 is formed at the exposed portions of the second and fourth conductive wires 22a and 24a. Note that the second conductive wire intertwining step is equivalent to the conductive wire contact portion forming step according to the present invention.

The right drawing of FIG. 19 illustrates a state in which the left drawing of FIG. 19 is rotated around the axis AC by 90 degrees.

The pressure-sensitive sensor 60 according to the third embodiment formed as described above can also provide the operational effects as similar to those of the first embodiment. Additionally, in the third embodiment, the short-circuit wire can be completely eliminated. Thus, the number of components can be further reduced. Further, the welding operation and the equipment therefor can be eliminated. Furthermore, the portion to be welded can be eliminated, and therefore, the failure in the welding or the like can be eliminated, and the reliability can be further improved.

### Fourth Embodiment

Next, a fourth embodiment of the present invention will be described in detail with reference to the drawings. The components having the functions similar to those of the first embodiment are denoted with the same reference symbols, and the detailed description thereof is omitted.

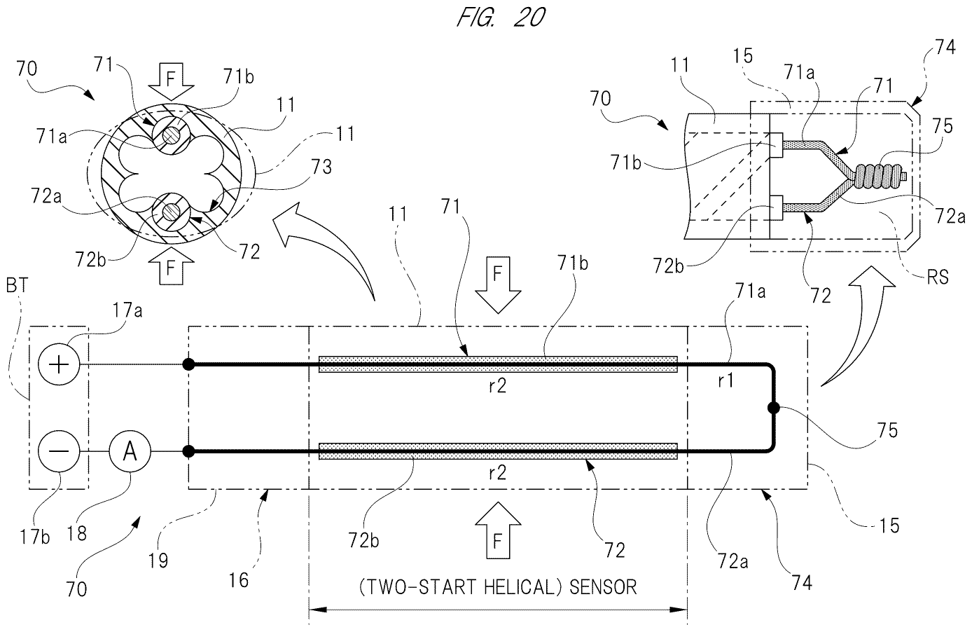

FIG. 20 is a diagram corresponding to FIG. 3, which illustrates a pressure-sensitive sensor according to the fourth embodiment.

As illustrated in FIG. 20, the pressure-sensitive sensor 70 according to the fourth embodiment is different from the pressure-sensitive sensor 10 (see FIGS. 1 to 3) according to the first embodiment in that the pressure-sensitive sensor 70 includes only a pair of electrode wires 71 and 72.

The pair of electrode wires 71 and 72 have the same configuration. The pair of electrode wires 71 and 72 include conductive wires 71a and 72a made of intertwined thin copper wires, and conductive rubbers 71b and 72b covering parts (corresponding to the detector) of the conductive wires 71a and 72a in the longitudinal direction, respectively.

The electrode wires 71 and 72 are provided at a portion inside the outer cover 11 in a radial direction and around a hollow 73. The pair of electrode wires 71 and 72 are arranged to face each other in the radial direction of the outer cover 11, and helically extend in the longitudinal direction of the outer cover 11. Inside the outer cover 11 in the radial direction, the pair of electrode wires 71 and 72 are not in contact with each other, and are arranged with a two-start helical structure.

The outer cover 11 is elastically deformed in response to the application of the external force F to the outer cover 11, thereby bringing the pair of electrode wires 71 and 72 into contact with each other (short-circuit) inside the outer cover 11 in the radial direction. A resistance value r1 of the entire conductive wire made of the conductive wires 71a and 72a connected in series is larger than a resistance value r2 of each of the conductive rubbers 71b and 72b (r1>r2). Note that each of the conductive rubbers 71b and 72b is made of, for example, silicon rubber or the like containing carbon black, metal powder, or the like.

Thus, when the pair of conductive rubbers 71b and 72b are not in contact, the current detector 18 detects a current value a3 of a current flowing in the entire long conductive wire made of the conductive wires 71a and 72a connected in series. To the contrary, when the outer cover 11 is elastically deformed by the application of the external force F to the outer cover 11, the pair of conductive wires 71a and 72a are mutually short-circuited (electrically connected to each other) through the conductive rubbers 71b and 72b.

Thereby, a current flows through the conductive rubbers 71b and 72b with the low resistance value r2, and the current detector 18 detects a current value a4 larger than the current value a3 (a4 >a3). Thereby, the in-vehicle controller senses an increase from the current value a3 to the current value a4, thereby finding out that the obstacle is in contact with the pressure-sensitive sensor 70.

As illustrated in FIG. 20, a conductive wire intertwined portion 75, which is formed by collectively helically intertwining one sides of the pair of conductive wires 71a and 72a exposed from the outer cover 11 in the longitudinal direction, is provided at a distal-end terminal 74 of the pressure-sensitive sensor 70. Note that the conductive wire intertwined portion 75 is formed as similar to the conductive wire intertwined portion 14 (see FIG. 5) according to the first embodiment. The conductive wire intertwined portion 75 formed by bringing the pair of conductive wires 71a and 72a into contact is equivalent to the conductive wire contact portion according to the present invention.

Further, the conductive wire intertwined portion 75 is also covered with the ultraviolet-curable resin RS and the distal-end cap 15 similarly to the conductive wire intertwined portion 14 according to the first embodiment. The distal-end terminal 74 of the pressure-sensitive sensor 70 is assembled almost as in the first embodiment except the short-circuit wire welding step in the first embodiment.

The pressure-sensitive sensor 70 according to the fourth embodiment formed as described above can also provide the operational effects as similar to those of the first embodiment. Additionally, the number of electrode wires of the fourth embodiment can be made half of that of the first embodiment, and therefore, the diameter and the weight of the pressure-sensitive sensor 70 can be reduced. Further, the electric circuit can be simplified, thereby further improving the durability.

It is needless to say that the present invention is not limited to the foregoing embodiments, and various modifications can be made within the scope of the present invention. In the above embodiments, the plurality of electrode wires having the four-start helical and the two-start helical structures have been described. However, the present invention is not limited thereto, and a six-start helical structure or an eight-start helical structure (“2×n”-start helical structure) may be applied depending on the application of the pressure-sensitive sensor or the like.

In the first to third embodiments, the example in which the first to fourth electrode wires 21 to 24 are made of the first to fourth conductive wires 21a to 24a and the first to fourth conductive rubbers 21b to 24b, respectively, has been described. However, the present invention is not limited to this example, and the first to fourth conductive rubbers 21b to 24b may be eliminated while the first to fourth conductive wires 21a to 24a may be electrically connected inside the outer cover 11 in the radial direction.

In the first embodiment, the example in which the first and third conductive wires 21a and 23a that are connected to each other through the short-circuit wire WL and in which the conductive wire intertwined portion 14 is provided at the second and fourth conductive wires 22a and 24a that are in direct contact with each other has been described. However, the present invention is not limited to this example. To the contrary, the conductive wire intertwined portion may be provided at the first and third conductive wires 21a and 23a that are in direct contact with each other, and the second and fourth conductive wires 22a and 24a may be connected to each other through the short-circuit wire.

In the second embodiment, the example in which the first and third conductive wires 21a and 23a are connected to each other through the short-circuit wire WL and in which the conductive wire welded portion 42 is provided at the second and fourth conductive wires 22a and 24a that are in direct contact with each other has been described. However, the present invention is not limited to this example. To the contrary, the conductive wire welded portion may be provided at the first and third conductive wires 21a and 23a that are in direct contact with each other, and the second and fourth conductive wires 22a and 24a may be connected to each other through the short-circuit wire.

In the third embodiment, the example in which the conductive wire intertwined portions 62 and 14 are provided at the first and third conductive wires 21a and 23a and the second and fourth conductive wires 22a and 24a, respectively, has been described. However, the present invention is not limited to this example, and the conductive wire welded portion may be provided at each of the first and third conductive wires 21a and 23a and at the second and fourth

### Conductive Wires 22a and 24a.

In the fourth embodiment, the example in which the conductive wire intertwined portion 75 is provided at one side of the pair of conductive wires 71a and 72a in the longitudinal direction has been described. However, the present invention is not limited to this example, and the conductive wire welded portion may be provided instead of the conductive wire intertwined portion 75.

In each of the above embodiments, the example in which any of the pressure-sensitive sensor 10, 40, 60 and 70 is mounted on the sliding door of the vehicle such as car and is used to sense the obstacle stuck in the sliding door has been described. However, the present invention is not limited to this example, and such a pressure-sensitive sensor may be used to sense, for example, an obstacle stuck in an automatic door of a building, an opening/closing door of an elevator, or the like.

Additionally, the materials, shapes, dimensions, numbers, installation places, and the like of the components in each of the above embodiments are optional items when achieving the present invention, and are not limited to those in each of the above embodiments.

What is claimed is:

1. A pressure-sensitive sensor which is elastically deformable in response to contact with an obstacle, comprising:
a hollow cable-shaped insulator;
at least a pair of conductive wires which are provided inside the cable-shaped insulator and are electrically connected to each other in response to elastic deformation of the cable-shaped insulator; and
a conductive wire contact portion which is provided at one side of the cable-shaped insulator in a longitudinal direction and is formed by bringing the pair of conductive wires into contact with each other.

2. The pressure-sensitive sensor according to claim 1,
wherein the conductive wire contact portion is a conductive wire intertwined portion formed by intertwining one sides of the pair of conductive wires in the longitudinal direction.

3. The pressure-sensitive sensor according to claim 1,
wherein the conductive wire contact portion is a conductive wire welded portion formed by welding one sides of the pair of conductive wires in the longitudinal direction.

4. The pressure-sensitive sensor according to claim 1, wherein the conductive wire contact portion is sealed with a sealing material having an insulation property.

5. A method of manufacturing a pressure-sensitive sensor which is elastically deformable in response to contact with an obstacle, comprising:
a workpiece preparing step of preparing a workpiece made of a hollow cable-shaped insulator and a pair of conductive wires which are provided inside the cable-shaped insulator;
a cable-shaped insulator cutting step of cutting the cable-shaped insulator to make the cable-shaped insulator separatable into a main body and a terminal member in a longitudinal direction of the cable-shaped insulator;
a conductive wire exposing step of separating the main body and the terminal member from each other to expose the pair of conductive wires between the main body and the terminal member; and
a conductive wire contact portion forming step of forming a conductive wire contact portion by bringing the pair of exposed conductive wires into contact with each other.

6. The method of manufacturing the pressure-sensitive sensor according to claim 5,
wherein in the conductive wire contact portion forming step, a conductive wire intertwined portion serving as the conductive wire contact portion is formed by collectively intertwining the pair of exposed conductive wires.

7. The method of manufacturing the pressure-sensitive sensor according to claim 5,
wherein in the conductive wire contact portion forming step, a conductive wire welded portion serving as the conductive wire contact portion is formed by welding the pair of exposed conductive wires.

8. The method of manufacturing the pressure-sensitive sensor according to claim 5,
wherein a sealing step of sealing the conductive wire contact portion with a sealing material having an insulation property is performed after the conductive wire contact portion forming step.
